(19) United States
(12) Patent Application Publication
(10) Pub. No.: US 2013/0238370 A1
(43) Pub. Date: Sep. 12, 2013

(54) EVENT PLANNING AND MANAGEMENT SYSTEM

(71) Applicants: James A. Wiseman, Vienna, VA (US); Scott G. Macleod, McLean, VA (US)

(72) Inventors: James A. Wiseman, Vienna, VA (US); Scott G. Macleod, McLean, VA (US)

(73) Assignee: Immersonal, Inc., Vienna, VA (US)

(21) Appl. No.: 13/413,520

(22) Filed: Mar. 6, 2012

(51) Int. Cl. G06Q 10/02

(52) U.S. Cl. 705/5

(57) ABSTRACT

A method and system is presented for recommending an event or activity to members of a group. The system and method may access a group profile that includes preference information for each of a plurality of members. The system and method may determine a group preference based on the group profile, where the group preference is based on a preference of at least one of the plurality of members. The system and method may select, from among a plurality of events or activities, an event or activity for the plurality of members of the group to attend or do. The selection may be based on the group preference. The system and method may further create an itinerary of the event or activity and any planned ancillary services, and may facilitate social media and other services for the event.

### FIELD OF THE INVENTION

The invention relates to systems and methods for recommending and managing events, activities, or ancillary services for a group of attendees.

### BACKGROUND OF THE INVENTION

Event planning has generally required a user to manually browse through databases of upcoming events and to narrow down all upcoming events to one or more events that match his or her own interests. Some systems have allowed a user to input his or her interests and to receive information about a recommended event based on such interests. Such systems, however, use those interests in a static manner, and fail to dynamically adjust the event information based on a context under which the user is planning the event. Further, if the user did find an event that interests him or her, the user generally had to separately purchase a ticket, separately plan how the user will get to the event and separately plan what the user will do before and after the event. Thus, there is a need for a more dynamic and comprehensive event and activity management application.

### SUMMARY OF THE INVENTION

According to one aspect of the invention, a system, method, and computer-readable medium is disclosed for recommending an event, such as a live performance, or activity to a person based on not only his or her preference, but on a preference of other people with whom the person wants to attend an event. For example, if a person intends to attend an event with a group of people, recommending an event to the person depends not only on the interests, budget, schedule, or any other preference of that person, but on the preferences of other people in the group. For example, whether the person would want to attend a sporting event, theater performance, concert, or other event would depend on whether that person is planning to attend the event with his or her spouse, his or her children, his or her friends, his or her supervisor from his or her workplace, or with another person. Recommended events will be different depending upon the composition of the group and one or more preferences of the individuals in the group. If the person intends to go to an event with a group of friends, an event that matches an interest of all group members may be recommended. If the person intends to go to an event with his spouse or children, an event that matches an interest of the spouse or children may be recommended even if the event does not match well with that person's individual interests. In such an example, the person may wish to accommodate an interest of the spouse or of the children. The system, method, and computer-readable medium may recognize that a person's preference is not static, and may depend on a persona (e.g., friend, spouse, parent, son or daughter, business colleague, etc.) under which the person is going to the event. The persona may depend on a relationship between the person and another member or members of the group. The relationship may affect whether the person prefers, for example, to have his or her individual preferences be more passive so as to accommodate a schedule, interest, or other preference of other group members, such as in accommodating a spouse or child. The relationship may affect what types of events are appropriate to recommend. In one example, a rock concert may be appropriate if the group members are friends with the person, but may not be appropriate if the group members are business clients of the person. In such an instance, a more traditional business development event, such as a sports game, may be recommended even though all group members are individually interested in rock concerts. In another example, a romantic dinner may be appropriate if a group member is a spouse of the person, but may not be appropriate if the group members are several business colleagues, even if each group member would separately prefer a romantic dinner with his or her own spouse when not with the group. The system, method, and computer-readable medium is thus operable to determine a group preference based on group membership, composition, and weightings amongst individual preferences of the group, and may recommend an event based on the group preference.

According to an aspect of the invention, the system, method, and computer-readable medium is disclosed for providing a comprehensive event planning service that includes recommending an activity or ancillary service (e.g., recommending both a concert and happy hour) before or after the event, scheduling the event, activity, or ancillary service in an itinerary and facilitating a payment or any other transaction related to the event, activity, or ancillary service. An activity may include, for example, dining, a happy hour, a dance club, shopping, sightseeing, seeing a movie, or any other outing that may be done in addition to attending the event, or in lieu of attending an event. An ancillary service may include a transportation service, a parking service, a lodging service, or any other service. The system, method, and computer-readable medium may further allow group members to collaborate in creating or modifying an itinerary, and may present an interactive map for creating or modifying the itinerary. Facilitating the payment may include not only automatically transmitting necessary payment information, but may include outputting an interface that allows members of the group to flexibly divide payments among themselves and to collaborate in other aspects of the event planning.

According to an aspect of the invention, the system and method provides a service that enhances an attending member's experience at the event. The service may relate to event administration, such as facilitating food concession purchase at an event, relate to providing multimedia content related to the event, relate to facilitating social networking discovery among attending members of the same or different groups at the event, or relate to facilitating social gaming among attending members of the same or different groups at the event. The system, method, and computer-readable medium may leverage member preference information that was collected for event recommendation and use it to facilitate social networking discovery or social gaming, for example.

The event management application may be implemented through one or more components, including a profile component that is configured to create profiles that indicate member or group preferences; a recommendation component that is configured to recommend one or more events or activities based on a member or group preference; an itinerary component that is configured to schedule one or more events, activities, or ancillary services; a transaction component that is configured to facilitate transactions related to the event or items on the itinerary; and a real time experience component that is configured to provide a service that enhances an attending member's experience at such activities or events.

According to one embodiment of the invention, the profile component is configured to create one or more individual profiles and is configured to create one or more group profiles. An individual profile may be associated with a member of the group and indicate the member's preferences. In some implementations, the individual member profile may be based on information received from the member or from another member acting as his or her proxy, on information gathered through the member's past use of the application (referred to as click through) and other browsing activity information of the member, on social media activity associated with the member, and on location information associated with the member. The individual profile may thus indicate what event or activity type, venue, time, price, performer, accommodation, or other event, activity and ancillary services are preferred by the user. One or more individual profiles may be aggregated into one or more group profiles by the profile component. Each group profile may be associated with a group made up of the members of the individual member profiles. One or more group preferences may be determined for the group profile.

In some instances, the group preference may depend on a preference of at least one group member, which may be indicated by the member's profile. For example, a group preference for a family may depend on a preference of a child in the family. The child's preference may be more heavily weighed or may override a preference of another member, such as of a parent. The system, method, and computer-readable medium may be configured to learn from past event attendances, for example, that the parent accommodates a preference of certain other members (e.g., the parent's spouse, niece, child, or mother).

In some instances, the group preference may depend on a preference of all group members. For example, a group preference for a group of friends may depend on a preference of all friends in the group. In another example, the system, method, and computer-readable medium may be configured to learn from past event attendances, for example, whether one friend's preference tends to be more dominant than another friend's preference. In such an example, the more dominant preference may be weighted more heavily or may override a preference of the another friend.

In some instances, the group preference may depend on a relationship of the group members. For example, if group members are business colleagues, the group preference may be for a business-appropriate event (e.g., sports game) or activity even if a less business-appropriate event or activity is more preferred by all group members. In such an example, the business-appropriate event or activity may be preferred at least to a degree by the group members, or may even be disliked by a majority of or all group members. In another example, if group members are family members, a family-friendly event or activity may be recommended.

The recommendation component may recommend an event or an activity to a group member based not only on his or her preferences, but also based on who else is in the group. That is, recommending an event or activity may be based on not only an individual member, but also on whom the member is attending the event with. According to one embodiment of the invention, the event recommendation component may be configured to recommend an event or activity based on a group preference.

The itinerary component may be configured to recommend one or more activities or recommend one or more ancillary services for the members before or after the event. The event or activity may include dining, lodging, transportation, parking, a happy hour, a club, shopping, or any other activity or ancillary service. The itinerary component may estimate a time that a service or activity may take, and may schedule the activity or service. In some implementations, the activity or service may be scheduled with a recommended event. In some implementations, the activity and any services may be scheduled without an event. In such implementations, the group may perform the activity that matches the group preference, such as going to a happy hour or to a club, without going to an event.

In some implementations, the itinerary component may allow a user to modify the itinerary by dragging or otherwise selecting an item representing a service or activity venue on an interactive map and dropping it on a list that represents the itinerary. In some implementations, the itinerary module may allow multiple members to collaborate on creating or modifying an itinerary. The itinerary component may create one or more itineraries for each member, and may allow the one or more itineraries to be compared.

The transaction component may be configured to facilitate one or more transactions related to the event or for an activity or service included in the itinerary. A transaction may include a purchase, a reservation, or any other transaction. The transaction may relate to the event, to the activity or service, or to event administration at the event. According to an embodiment of the invention, the transaction component may allow members of the group to divide payment among themselves. For example, the transaction component may receive from one or more members of the group a percentage of a transaction that he or she will pay. The transaction component may communicate with one or more third party servers to process payment.

The real time experience component may be configured to provide services that enhance a member's experience at an activity or event. The services may include social media services, such as facilitating social networking discovery among attending members, facilitating social gaming among attending members, broadcasting event-related multimedia content to attending members, facilitating event administration, or facilitating capturing or sharing of multimedia or comments. According to one aspect of the invention, providing the real-time services may leverage information already collected by the profile module or transaction module. For example, facilitating social networking discovery may be based on social networking information collected for creating member and group profiles. Such social networking discovery may be performed before attending members arrive at the event or activity because their social networking information has been collected. In one example, when access to an event or activity has been reserved for a member through the transaction component, his or her interests or background may be matched with other members who have reserved access to the event or activity. Before the event or activity or at the event or activity, a member may be notified of one or more other attending members with similar interests or background. Similarly, for facilitating social gaming, participants in the game may also be determined before attending members arrive at the event or activity.

Other objects and advantages of the invention will be apparent to those skilled in the art based on the following drawings and detailed description.

### BRIEF DESCRIPTION OF THE DRAWINGS

FIG. 1 illustrates an example event or activity management environment capable of providing a comprehensive event or activity planning service to users.

FIG. 2 illustrates example third party servers that may interact with a system of the event management environment.

FIG. 3 illustrates an example view of an itinerary generated by the system of the event management environment.

FIG. 4 illustrates an example view of an interface for user collaboration in the event management environment.

FIG. 5 illustrates an example view of an interface for viewing details of an itinerary.

FIG. 6 illustrates an example system for providing event- or activity-based services at an event.

FIG. 7 illustrates an example process for receiving event- or activity preference information associated with a user.

FIG. 8 illustrates an example process for determining a group preference.

FIG. 9 illustrates an example process for generating an itinerary based on an event or activity.

FIG. 10 illustrates an example process for facilitating event or activity-based social networking.

FIG. 11 illustrates an example process for facilitating event or activity-based social gaming.

### DETAILED DESCRIPTION

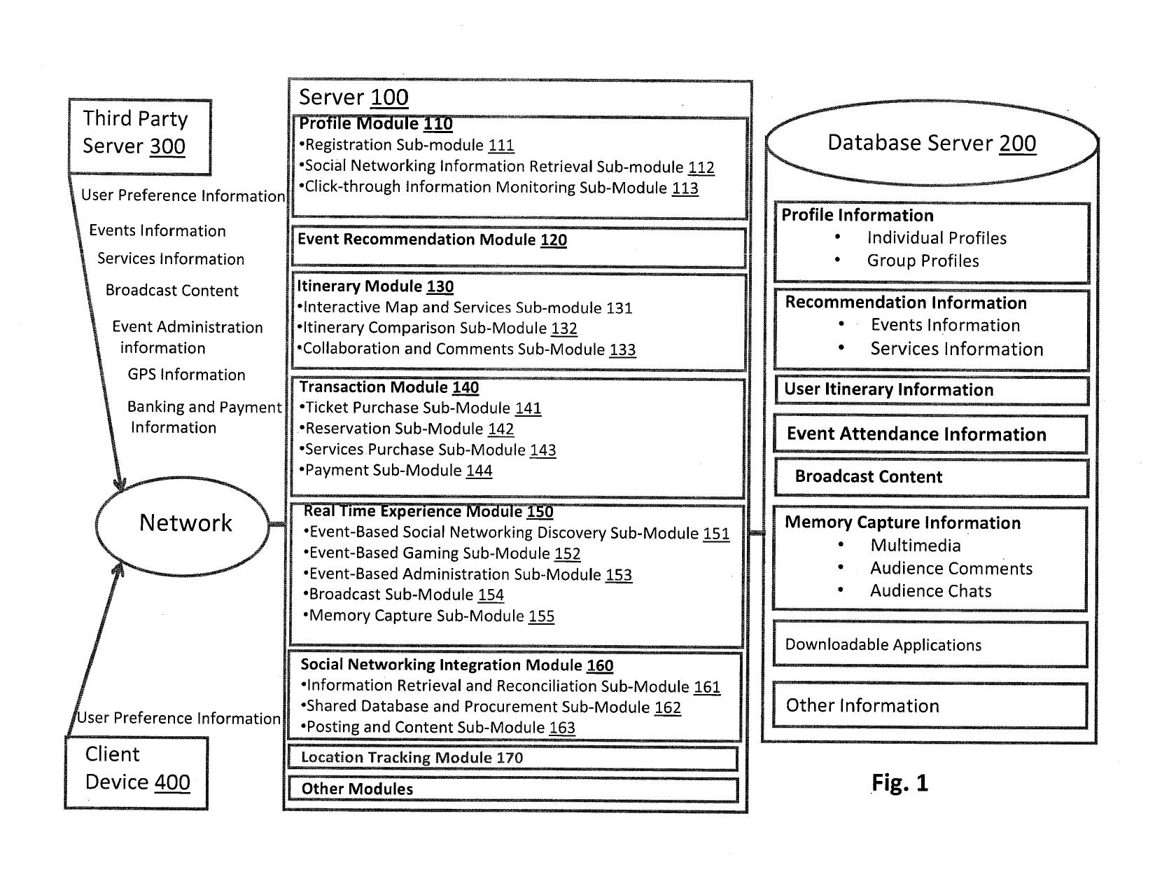

According to one aspect of the invention, FIG. 1 illustrates an example system, method, and computer-readable medium for providing an event management application. In some implementations, the event management application may recommend an event (e.g., concert, sports game, theater) or activity (e.g., a dinner at a restaurant) to a user based on his or her preferences as well as based on whom he or she intends to attend an event with. That is, recommending an event or activity to a user may be based not only on the user's own interests or preferences, but also on what other person or persons may also attend the event or activity with the user, on the interests or preferences of the other person or persons, and on whether the user would need to accommodate the interests or preferences of the other person. For example, an event recommended to a user who intends to go alone may be different than an event recommended to a user who intends to go with his or her family, friends, business colleagues, business clients, or any other group of people. The event management application may thus recommend an event based on whether the user wants to attend an event with a group and who is in that group.

According to one aspect of the invention, the event management application may provide concierge-like services that go beyond event or activity recommendation. For example, the event management application may recommend a service for transportation to the event, parking at the event, lodging, or any other service that is ancillary to the event. In some implementations, the event management application may recommend an activity, such as dining or going to a dance club, before the event or after the event. The event management application may generate an itinerary that schedules one or more events, activities, or ancillary services. Multiple itineraries may be generated and presented to a user for comparison. The event management application may thus relieve a user from having to separately plan and arrange activities and services. In some implementations, the event management application may facilitate a transaction, such as payment, related to the event or to a service or activity. The event management application may be configured to recommend an activity or a ancillary service in a manner similar to recommending an event. That is, an activity or service that is recommended for a person may be based on not only a preference of that person, but on another person or persons with whom that person will share that activity or service. As discussed in more detail below, the event management application may recommend an activity not only before or after an event, but in lieu of an event. For example, if no upcoming concerts, sports games, theater performances, or other events matches a group preference, the event management application may be configured to instead recommend an activity, such as sightseeing, shopping, dining at a restaurant, going to a bar, going to a club, seeing a movie, attending a party, or any other outing.

In some implementations, the event management application may facilitate collaboration among members of the group. For example, the event management application may present one or more interfaces that allow members to generate or modify an itinerary, or to divide payment for an event or for a service or activity.

According to one aspect of the invention, the event management application may provide content or service that enhance the experience of an attending member at the event or activity. The service or services may include social gaming at the event, social networking at the event, or an event administration service (e.g., a concession service). For such services, the event management application may leverage profile information that it received to facilitate social media activity among attending members of various groups.

Returning to FIG. 1, the event management application may be part of an event or activity management environment. The environment may include server 100, database sever 200, third party server 300, client device 400, and a network. The event management application may be implemented on server 100, as illustrated in FIG. 1, on a single server or any other computing device, or on a plurality of servers or other computing devices. Information related to event management may be stored on database server 200, as illustrated in FIG. 1, on a single database server or any other storage device, or on a plurality of database servers or other storage devices. Server 100 may be configured to provide an event or activity management service to client device 400 through a network. For example, server 100 may be configured to output an event or activity recommendation to client device 400. A recommendation may be pushed from the server to the client device, or the client device may remotely access the server to obtain the recommendation. Such remote access to server 100 may include interactive voice-based communication with server 100. Device 400 may be a desktop, laptop, or tablet computer, a monitor, a mobile device, or any other computing device having a user interface. In some implementations, server 100 may be configured to communicate with a third party server 300 information related to event management.

The event management application may be at least partially implemented through one or more modules, including a profile module 110, recommendation module 120, itinerary module 130, transaction module 140, real time experience module 150, social networking integration module 160, location tracking module 170, and any other module. The one or more modules may be implemented on server 100, or on any other computing device or devices. The one or more modules may comprise instructions stored on server 100 and may be executed by one or more processors on server 100 or on any other computing device.

Profile module 110 may be configured to generate one or more profiles that are indicative of user or group preference, and may be configured to update the one or more profiles. Profile module 110 may be configured to generate one or more individual member profiles and one or more group profiles. Such profile information may be stored on database server 200 or any other storage device. An individual member profile may indicate a preference of a member associated with the individual member profile. The preference may relate to preference for a type of event or activity (e.g., sports game or ballet or dancing or viewing movies), a performer (e.g., sports team or composer or musician or band), cost (e.g., maximum ticket price), a time (e.g., day of week, time of day, or season), a venue (e.g., a specific stadium, park, or theater), proximity to types of transportation (e.g., accessible to bus or subway), location (e.g., within 35 miles from member's home), presence of accommodation (e.g., wheelchair accessible), or any other preference.

The member profile may be created from user-provided information, social media activity information, information gathered through the member's use of the management application (e.g., clickt-through information), location-based information, or any other information. User-provided information may be collected by, for example, registration sub-module 111. The sub-module may be configured to output an interface through which preference information may be collected. Outputting information may include transmitting information to a client device, which may present the information on a user interface. The interface may present, for example, one or more questions that solicit preference information related to a member. The member may be a user of the client device, or another person on whose behalf the user is inputting the preference information. For example, the user may provide information for a member who is too young to use the event management application or for a friend who is too busy to register with the event management application. In some implementations, sub-module 111 may present an interface that collects account information, such as user name, contact information, password information, payment information, or any other account information.

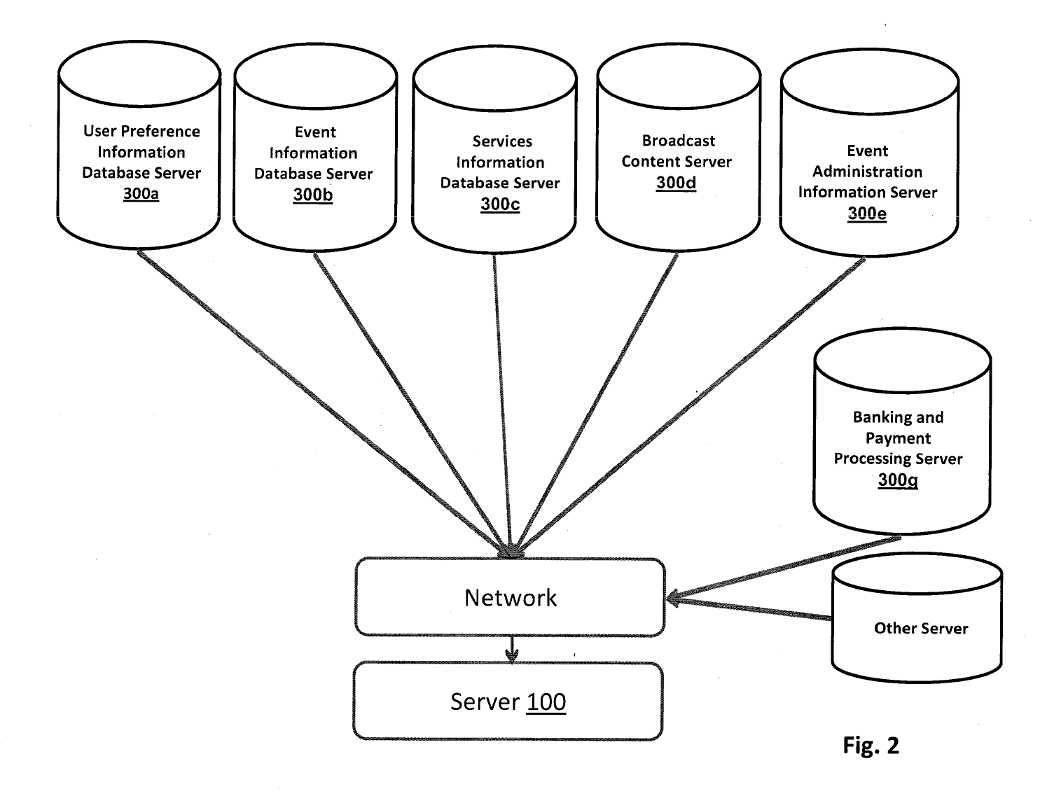

Social media activity information associated with a member may be collected by, for example, social networking information retrieval sub-module 112. In some implementations, the sub-module may output an interface that collects information related to social media used by the member. For example, the interface may present the user with an ability to grant access to a social networking, blogging, tweeting or other social media accounts used by the member. If the user grants access, sub-module 112 may be configured to communicate with third party social media systems, such as Facebook™, Twitter®, Google+®, LinkedIn®, or any other social media system to receive information related to preferences from such third party social media systems. Such information may be received from a third party server 300, or more specifically a user preference information database server 300a (shown in FIG. 2). Such information may include a rating given by the member, a preferred performer, venue, or type of event or activity indicated by the member, any search keyword or comment inputted by the member on the social media system, or any other preference information. In some implementations, interaction with third party social media systems may be performed through social networking integration module 160. For example, sub-module 112 may rely on executing information retrieval and reconciliation sub-module 161. Sub-module 161 may be configured to retrieve information from one or more servers of a social media system, may be configured to consolidate redundant information from different social media systems, and may be configured to reconcile conflicting information from different social media systems.

User information may be collected by system use or clickthrough information monitoring sub-module 113. Sub-module 113 may track, for example, online activity received at server 100 or at another server. The online activity may include a search term made by the member, an event-related website visited by the member (e.g. a sports team website), a time of day or day of week in which the member visited the website, a price that the member clicked on, a type of transportation that the member clicked on, a disability accommodation the user clicked on, or any other event preference information.

Location-based information may be collected by location tracking module 170. For example, location tracking module 170 may be configured to receive, from a GPS device on client device 400, a member's location or may be configured to communicate with a third party server to determine a user's location. The third party server may include, for example, a social media system that allows a member to check in with his or her location. The event management application may be configured to determine, based on the location information, a day of week, time of day, or season in which the member is most frequently in proximity to an event or activity, a venue most frequently in proximity to the member, a type of event, activity or transportation most frequently in proximity to the member, or any other preference information.

Profile module 110 may be configured to generate a group profile based on information collected for individual member profiles, and may be configured to update the group profile. The group profile may be associated with a group made up of one or more members. A user may indicate, such as from client device 400, which member or members belong to the group. In some implementations, the group profile may include individual member profiles of one or more members of the group. If a group member is not a user of the event management application, the application may use a proxy individual member profile that was created or is to be created on the member's behalf. A group may include a plurality of members, or may include a sole member.

In some implementations, profile module 110 may be configured to determine a group preference for the group. The group preference may affect what event or activity is recommended for the group to attend or do, and may be based on who is in the group. The group preference may depend on a preference of one or more group members, on whether a preference of one member is to be weighted more heavily, on a relationship among the group members, or any combination thereof. If the group preference is based on a preference of all group members, for example, module 110 may be configured to access all individual membership profiles of the group profile and determine one or more preferences (e.g., type of event or activity or time of event) that is common to all group members or to a majority of group members. For example, module 110 may be configured to determine that all or a majority of members of a group of friends would prefer an event such as a sports event or a rock concert.

In some cases, profile module 110 may be configured to determine whether one member of the group may need to accommodate a preference of another member. For example, if the group included children, profile module 110 may weigh their preferences more heavily than preferences of adult members of the group. If a member has a disability, for example, that member's preference for disability accommodations may be weighted more heavily over a venue preference of another member of the group. In some cases, profile module 110 may be configured to learn from past event attendances whether a member prefers to accommodate an interest of another group member. For example, module 110 may access an event or activity attendance history that indicates when the member attends an event or activity with his or her children, the event or activity matches well with an interest of the children but not with the member's interests. Module 110 may thus determine that the member may prefer to accommodate an interest of at least his or her children. The history may indicate that when the member attends an event with his or her friends, the event matches well with the member, and not as well with his or her friends. Module 110 may thus determine from the history that the member's preference tends to dominate or have influence when the member attends an event with his or her friends.

In some instances, the group preference may depend on a relationship of the group members. The relationship may affect whether a member defers to another, such as when a parent defers to an interest of his or her children, but may further affect whether an event or activity is appropriate to recommend even when all group members have indicated an interest in the event or activity. For example, two acquaintances may both enjoy a dinner cruise, but only with their respective spouses, and not with each other. Profile module 110 may determine, based on a relationship between the two members, whether a dinner cruise is appropriate. A relationship may be based on a default category, such as a business, family, marital, or friendship relationship, or may be a customized relationship. For example, a person may have different relationships with different acquaintances, and what is an appropriate event or activity may be different for each of the different relationships. Profile module 110 may be configured to associate, such as based on past event attendances, which events or activities are appropriate to recommend for each of the different relationships. In some instances, the relationship may affect whether an event is appropriate even when all or a majority of group members indicate a lack of interest in the event. For example, if the relationship among group members is that of business colleagues, an activity such as a networking function may be recommended even if a majority of members show no interest in networking functions in their individual member profiles.

Event recommendation module 120 may be configured to recommend an event or activity for a group to attend. Module 120 may output an event or activity recommendation to client device 400, for example. Information on upcoming events may be stored on database server 200 or any other storage device. In some instances, information about upcoming events may be collected from a third party, such as event information database server 300b, shown in FIG. 2. The information may be collected by, for example, module 120.

Module 120 may be configured to recommend an event or activity based on a group preference. The module may recommend an event or activity to a group member, such as a user of client device 400, based who else is in the group. If the group profile indicates that sufficient group members prefer a concert having a particular genre at a particular venue, a concert event having that genre or a similar genre at the venue may be recommended. In some implementations, module 120 may recommend an event or activity based on whether one group member needs to accommodate another group member. For example, if one group member is a parent and another group member is the parent's child, module 120 may weigh more heavily the child's preference by default or based on a past event or activity in which the parent and child attended together. In another example, if the user of client device 400 requests a recommendation for a group including only the user and his or her spouse, preferences of the spouse may be weighted more heavily by default or based on past events in which the two people attended together. A past event or activity may indicate, for example, which spouse tends to accommodate an interest of the other.

In some implementations, module 120 may be configured to search a database of upcoming events, such as database server 200, for an event matching the group preference. In some implementations, module 120 may be configured to rank categories of preferences. For example, matching a preferred event or activity type, venue, or cost may be more important than matching a preferred time or accessibility to transportation. In some implementations, module 120 may be configured to specify how closely the event must match the group preference. For example, module 120 may recommend only events matching a preferred musician, or may recommend events having a similar musician. The event recommendation may be outputted to all group members or to only a subset of group members, such as to the user of client device 400.

The event management application may be configured to recommend one or more activities or ancillary services based around a recommended event or activity or based around an event or activity that a member selected on his or her own. One or more activities based around an event may include, for example, shopping before a recommended concert, seeing a movie before a recommended sports game, dining at a restaurant before a user-selected ballet performance, drinking at a bar after a user-selected sports game, or dancing at a club after a user-selected concert. One or more activities based around another activity may include, for example, shopping before seeing a recommended movie, dancing at a club after a user-selected happy hour, or dining after a recommended networking function. Itinerary module 130 may be configured to arrange the one or more activities or services in a schedule. In some cases, the schedule may include multiple events. For example, in addition to a recommended concert, a comedy club performance before the concert may have been recommended by module 120 or selected by the member on his or her own.

In some instances, the one or more activities may be recommended in lieu of an event. For example, if the database of upcoming events searched by event recommendation module 120 included only live performance events, and if a person did not wish to attend a live performance, itinerary module 130 may create an itinerary having just activities, such as dining at a restaurant, going to a bar, going to a club, shopping at a store, visiting a museum, sightseeing, taking a tour, visiting a bed and breakfast, seeing a movie, attending a party, or any other outing, as well as any ancillary services based around the one or more activities.

Like recommending an event, recommending an activity for a person may also be based on whom the person wants to do the activity with. For example, if a person wants to do an activity with a group that includes him and his friends, an activity that matches a preference of all group members (e.g., going to a bar) may be recommended. If the person intends to do an activity with a group that includes his spouse or children, an activity that matches a preference of the spouse or children (e.g., going to Dave and Busters) may be recommended even if the activity does not match well with that person's own preference. A group preference may be determined for recommending an activity to be performed by the group. In some implementations, the group preference used to recommend an activity is the same group preference used to recommend an event. In some implementations, the group preference used to recommend an activity may be based on additional information, such as food preference (e.g., for dining), a preference against cover charges (e.g., for going to a club), or favorite movie actor (e.g., for seeing a movie), or any other additional preference information from the member profiles or from any other source. The group preference used to recommend an activity may be based on a preference of one or more group members, on whether a preference of one member is to be weighted more heavily, on a relationship among the group members, or any combination thereof. The group preference may be determined, for example, by profile module 110.

In the examples above, modules 120 and 130 may be configured to allow a user to select an event or an activity on his or her own, and may recommend one or more other events, activities, or an ancillary service based on the event or activity that is selected by the user.

The one or more ancillary services may include a transportation service, parking service, dining service, lodging service, or any other ancillary service. Services information may be stored on database server 200 or any other storage device. In some instances, the services information may be retrieved from a third party server, such as services information database server 300c, shown in FIG. 2. Server 300c may provide information directly from a service vendor or from an intermediary party, such as a compiler of ancillary services.

In some implementations, module 130 may recommend a service in a manner similar to how an event or activity is recommended. That is, recommendation of a service may also be based on member or group preferences. The preferences may include a type of activity, a location or proximity of the activity or service (e.g., proximity of a parking service to the event), accessibility to public transportation, cost, wait time, whether the service location permits smoking, availability of a disability accommodation, a rating, or any other preference. The preference may depend on a relationship among group members. For dining service, for example, a gourmet restaurant may be recommended for group members who are business colleagues, while a fast food restaurant may be recommended for group members who are friends.

If an itinerary becomes unusable because the event has sold out or an activity has been cancelled, or if a group member indicates a schedule change that conflicts with the itinerary, itinerary module 130 may be configured to detect the conflict. For example, module 130 may be configured to periodically compare one or more itineraries against a group member's time preference, cost preference, or any other preference. If module 130 detects a conflict between the itinerary and a member preference, it may output the conflict to one or more group members. Module 130 may further be configured to automatically generate one or more alternatives to the conflicted itinerary.

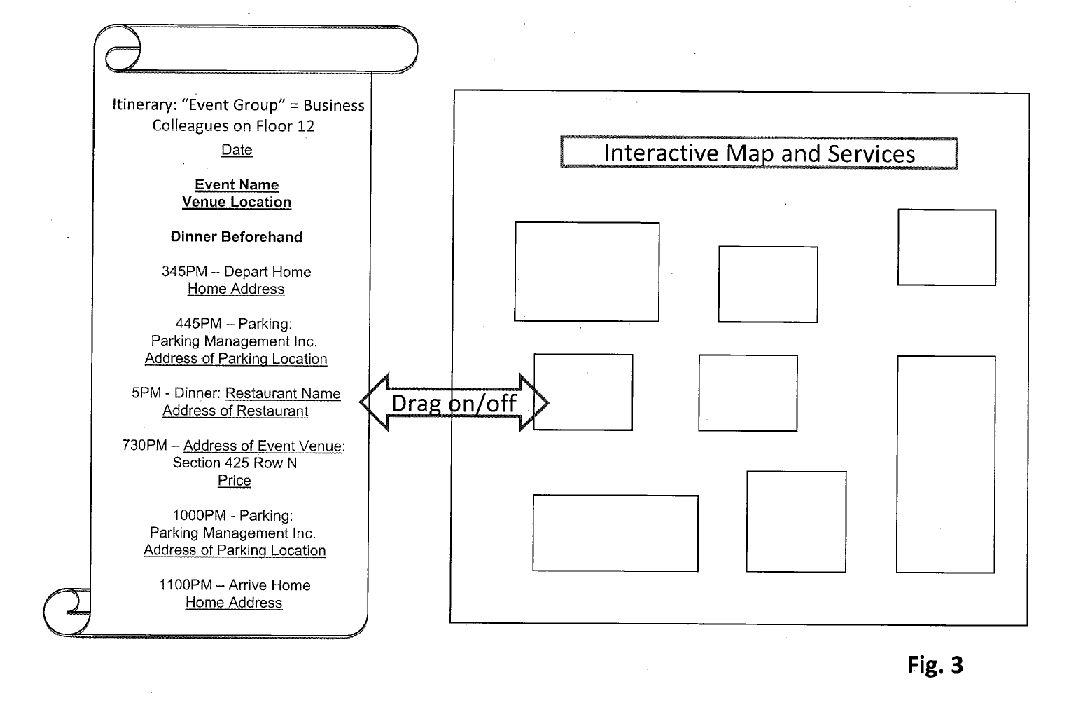

Itinerary module 130 may include an interactive map and services sub-module 131, which may be configured to output an interactive map that indicates a location of the event, an activity, or ancillary service on the map. The outputted map may be presented on, for example, client device 400. An example view of an itinerary and a map is presented in FIG. 3. The example view may be an interface generated by a client application. The client application may be downloadable or accessed by client device 400 from database server 200 or any other storage device. Database server 200 may be accessed via, for example, a keyboard, touch, voice input, or any other input transmitted from the client device. The client application may be configured to, for example, receive event or itinerary information outputted from module 130 of server 100 and present such information on client device 400. The itinerary presented by the client application may include ancillary services such as dining and parking, and may present them in a schedule. The schedule may be based on, for example, one or more estimated travel times, dining times, wait times, or any other scheduling-related times determined by module 130. Information shown on the itinerary may include an address, cost, rating, reservation number, wait time, or any other information related to an activity, service, event, or any other itinerary item.

A map may be presented with the itinerary to show an event, activity, or service location. The client application may receive map information from server 100, or may be configured to obtain map information from a third party server such as a map information server. In some implementations, the map may be interactive by allowing a listed itinerary item to be dragged on the map or a map item to be dragged to the itinerary. Dragging an itinerary item to the map may display the item's location on the map, while dragging the map item to the itinerary may add an event, activity, or service associated with the map item to the itinerary. In one example, if a user drags an itinerary item to the map, the client application may be configured to communicate address information associated with the itinerary item to the map information server, and to locate and display the itinerary item on the map. In one example, a user may search for activities or services (e.g., restaurants, bars, parking, hotel, movie theaters) around the event and may view them graphically overlaid on a map of the event location and its surrounding area. The user may select a service, such as dining service at a restaurant, by dragging a representation of the restaurant from the map to the itinerary. The client application may then communicate information associated with the restaurant to module 130. In response, module 130 may update the itinerary by adding dining at the restaurant to user itinerary information on database server 200, and may output the updated itinerary information to client application on client device 400.

Itinerary module 130 may be configured to generate multiple itineraries, including one or more itineraries for each group member. Group members may thus depart from different locations or dine or park at different locations before the event, or may participate in different activities after the event. For each group member, multiple itineraries may be generated to provide selection or flexibility to the group member. In some implementations, module 130 may include an itinerary comparison sub-module 132 that is configured to determine one or more differences or overlaps among itineraries of different group members or of one group member. Multiple group members may thus view from an output of module 132 how their itineraries overlap, or one group member may view from the output of module 132 how alternative itineraries compare against each other in terms of cost, rating, time, or any other feature.

In some implementations, module 130 may be configured to present a first view showing all activities or services before an event and a second view showing all activities or services after the event. Members who have children, for example, may then be able to focus on the first view, while members who may prefer to stay out may focus on the second view.

In some implementations, module 130 may be configured to present a view showing all of one type of activity or ancillary service around an event or another activity's location. Views can include all restaurants within a certain vicinity (e.g., within 2 miles) of the event or activity, all hotels within a certain vicinity of the event or activity, all bars within a certain vicinity of the event or activity, all clubs within a certain vicinity of the event or activity, all museums within a certain vicinity of the event or activity, or any other ancillary service or activity around an event or another activity's location.

In some implementations, as a member is modifying or creating an itinerary, module 130 may be configured to provide content related to an event, activity, or service on the itinerary. For example, if the event is a concert, module 130 may be configured to output music or a license to music by a performer of the event. The member's client device may receive the music or license and play the music as the user is modifying or creating the itinerary.

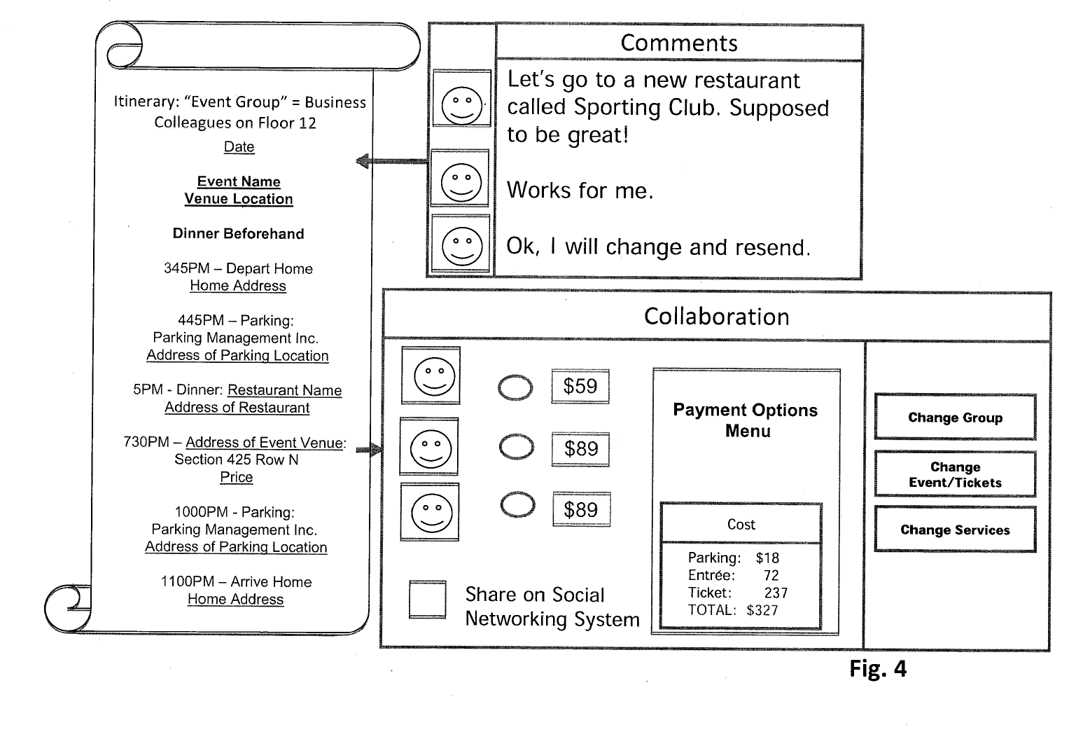

Itinerary module 130 may include collaboration and comments sub-module 133, which may be configured to allow multiple members to collaboratively generate an itinerary for those multiple members or for any other members. FIG. 4 shows an example view of collaboration among, for example, three members in creating an itinerary for the three members. In the example view, a group member may be able to communicate comments, conduct polls, or make itinerary changes that can be viewed by all members. A comment, poll response, or itinerary change may be reviewed, for example, from a client application executing on one client device, and may be relayed by module 133 to one or more client devices of collaborating group members. The multiple group members are thus able to view comments and actions from other group members. Further, as shown in FIG. 4, module 133 or the client application may present the group members with an option to share their attendance at an event, activity, or service on a social networking system. One or more group members may be invited to the collaboration or may join the collaboration without invitation through the social networking system. In some implementations, collaboration and comments sub-module 133 may rely on executing profile module 160, or more specifically shared database and procurement module 162. Sub-module 162 may allow users to collaborate through a social networking interface, such as of a third party social networking system. Sub-module 162 may implement an API such as Facebook® Connect to allow members to interact with their social networking systems through the event management application.

The example view in FIG. 4 further shows an interface that allows group members to divide payment for the event, for one or more activities, or one or more services. Module 133 may be configured to receive, for example, an amount or percentage that a group member intends to pay, and may be configured to determine whether the total payment from all collaborating members equals the total payment due.

Payment, reservation, or any other transaction for an event, activity, or service may be implemented by transaction module 140. Payment information may be stored on database server 200, such as in the individual member profiles, or on any other storage device. Module 140 may be configured to communicate with profile module 110, event recommendation module 120, or any other module or storage device to obtain ticketing information or to purchase a ticket for an event. Module 140 may include, for example, a payment sub-module 144 configured to communicate payment information to a third party server 300, such as banking and payment processing server 300g, shown in FIG. 2, to process a payment.

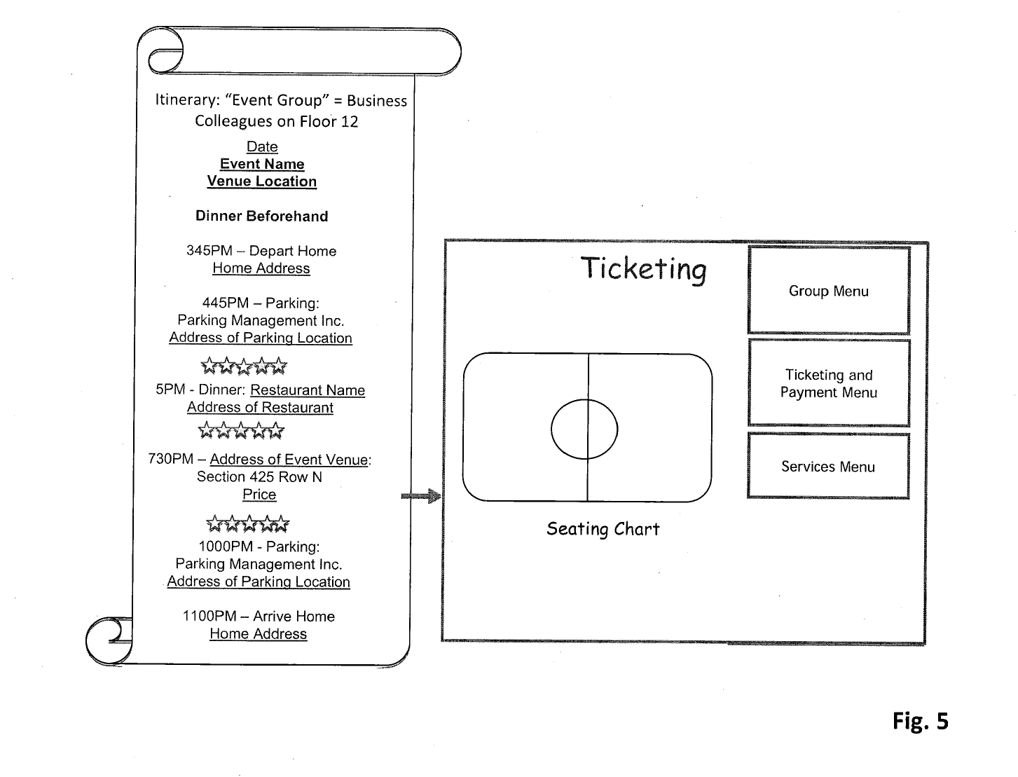

Module 140 may include a ticket purchase sub-module 141, which may be configured to facilitate purchasing of a ticket. For example, module 141 may be configured to communicate with a ticket distributer, a ticket reseller, or intermediary service. For example, for a sports event, module 141 may be configured to obtain ticket availability and prices from one or more ticket distributers affiliated with the sports event, from one or more ticket resellers unaffiliated with the sports event, or from any other source. Payment availability and pricing may be outputted to client device 400, for example. FIG. 5 shows an example view that may display a seating chart at a venue. Pricing information outputted by ticket purchase sub-module 141 may be displayed in relation to seating on the seating chart. Information outputted by sub-module 141 may further include comparison of prices across seating options. If the group member selects one or more tickets through the seating chart or in any other way, sub-module 141 may be configured to cause payment sub-module 144 to communicate payment information to a third party server to purchase the ticket. Sub-module 144 may communicate payment information of one or more group members. The amount associated with each group member may be determined from collaboration and comments sub-module 133. An address or addresses to which the one or more tickets are to be delivered may be determined from profile module 110.

Transaction module 140 may include a reservation sub-module 142, which may be configured to reserve access to an event, activity, or service. For reservation to an event, reservation sub-module 142 may reserve a ticket or other form of access before the ticket is purchased by payment sub-module 144. In some implementations, sub-module 142 may update event attendance information on database server 200 once a member has reserved access to an event. In some implementations, sub-module 142 may be configured to communicate with social networking integration module 160, discussed in more detail below, to update the attendance information with a social networking system of the member. For reservation of a service, such as dining at a restaurant, sub-module 142 may be configured to communicate with a third party server to reserve access, such as seating, for the service. Sub-module may communicate directly with the service provider, or may communicate with an intermediary, such as a with OpenTable® or any other restaurant reservation management system.

Transaction module 140 may include services purchase sub-module 143, which may be configured to facilitate purchasing of a service or access to an activity. In some implementations, information for sub-module 143 may be provided to itinerary module 130. In some implementations, services purchase sub-module 143 may be configured to obtain price information directly from a service or activity provider, or from a system that compiles service information, such as Expedia® or Hotels.com®. Sub-module 143 may be configured to communicate price information to payment sub-module 144, which may communicate payment information directly to the service or activity provider, or to the service compilation system. As discussed above, payment sub-module 144 may be configured to communicate with collaboration and comments sub-module 133 to determine a percentage or amount of the total payment to allocate to each group member.

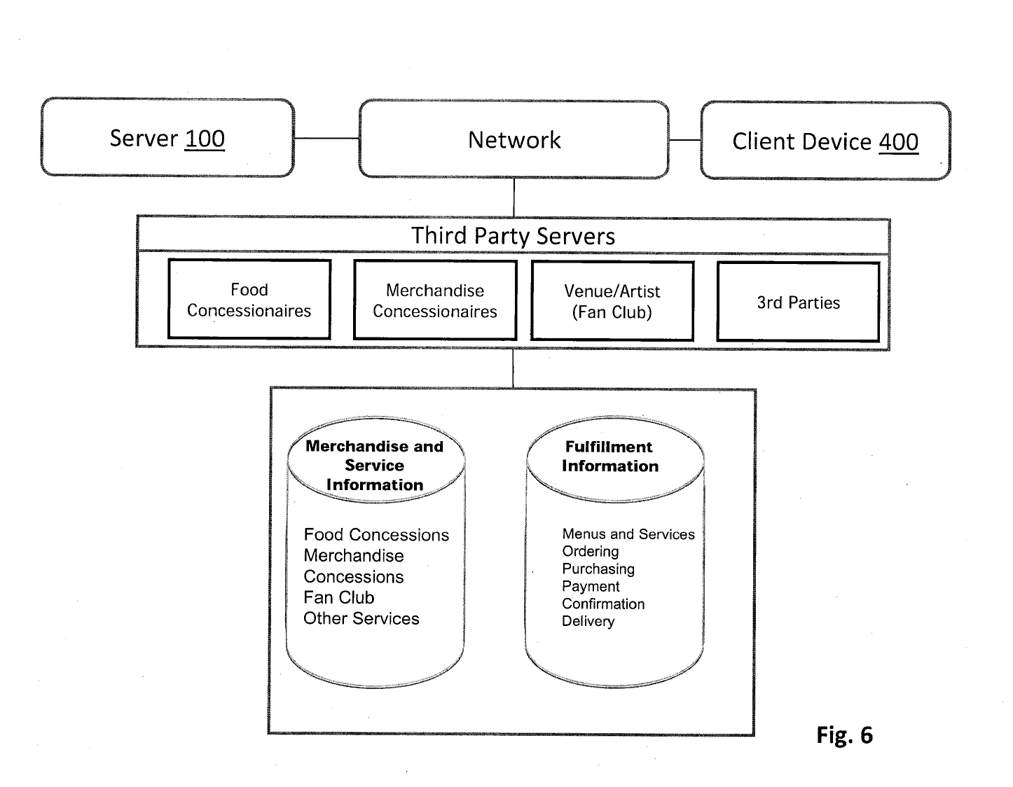

The event management application may include real time experience module 150, which may be configured to enhance a member's experience at an event or activity by simplifying event administration, providing event-based or activity-based media content, or providing event-based or activity-based social media. Event administration may include, for example, purchase of food, merchandise, or services at the event. Module 150 may include event-based administration module 153, which may be configured to communicate with one or more food, merchandise, or services vendors at the event. Module 150 may be configured to determine available administration services from event administration information server 300e, which is illustrated in FIG. 2. A more specific example is illustrated in FIG. 6. FIG. 6 shows that event administration information may be received from one or more servers that stores information related to food concessions, merchandise concessions, fan club-related event administration services, and other third party event administration services at the event or at an activity. The information may include prices, menus, accepted types of payment, delivery options, or any other information. Module 153 may be configured to output available food, merchandise, or services to a client device 400, for example, and may be configured to receive the member's selection from the client device. Mbdule 153 may be configured to cause payment sub-module 144 to transmit order and payment information to the food, merchandise, or services vendor.

In some implementations, module 153 may receive a member selection of how an administration service is to be fulfilled. For example, the member may select an option to pick up purchased merchandise, or may select an option to have the merchandise delivered to his or her seat. If the member's event seating was stored as part of a ticket purchase, the seating information may be transmitted to the vendor, who may be able to use the seating information to deliver food, merchandise, or services to the member. Module 153 may be configured to communicate with location tracking module 170 instead of or in addition to communicating seating information to the vendor. For example, if the member's event seating was not stored, or is not applicable, module 153 may be configured to receive a member location from location tracking module 170, which may poll a GPS device on the member's client device to determine the member's location. Module 153 may thus be configured to simplify event administration, relieving a user from having to wait in line at a concession stand or having to manually input payment information to a vendor website.

Event-based media content may include a picture, music, video, or any other multimedia related to the event or to an activity. Broadcast module 154 may be configured to provide the multimedia content from database server 200 or any other storage device, or may be configured to provide a license that a client device may use to obtain the content from a third party server 300, such as broadcast content server 300d, illustrated in FIG. 2. In some implementations, the content or license may be outputted only if a person attempting to access the content has paid for the access by purchasing a ticket to the event or by another method. For example, if server 100 receives a request from a client device to access video content associated with the event, broadcast module 154 may be configured to determine an identity of a member using the client device and whether the member has purchased a ticket or other form of access to the event. In such an example, the content may be outputted by server 100 only if the member has purchased access to the event. Determination of whether a member has purchased access may rely on information previously collected by the event management application, such as event attendance information on database server 200, information collected by profile module 110, information collected by ticket purchase sub-module 141, or any other information. Thus, rather than broadcasting event-related content to people who are only tailgating in proximity to the event, the event management application may leverage information that it previously collected for event recommendation and itinerary management to make the content available to only members who have purchased access to the event. In some implementations, the member may have to be at or otherwise in proximity to the event before he or she can receive the content, while in other implementations the member may receive the content at any location. In some implementations, the member may be able to receive the content only within a predetermined time window, such as an hour before the event to one week after the event.

The content may include a stream of the event itself from one or more cameras positioned at various locations or angles at the event. A member may thus view the event while, for example, standing in line at a concession stand or tailgating outside the event. Broadcast module 154 may provide a DVR-like functionality by allowing a member to rewind or fast forward the content. The content may include pre-recorded content, such as performer interviews, rehearsals, warm-ups, commercials or other marketing multimedia, or any other pre-recorded content. Broadcast module 154 may be configured to determine a language preference, such as from profile module 110, of a member and provide content in a preferred language.

Real time experience module 150 may provide event-based social media through event-based social networking discovery module 151 and event-based gaming module 152. Event-based social networking discovery module 151 may be configured to facilitate social networking discovery among members of one or more groups who are attending the event or an activity in proximity to the event, such as a tailgating party by the event or dining at a restaurant close to the event. Social networking discovery may include discovering other attending members with a similar interest (e.g., favorite artist or athlete, preferred type of music), background (e.g., attending the same school, working in the same company, field, or community), discovering that a friend or acquaintance is also attending the event or activity, or any other social networking discovery. An attending member who discovers another attending member may be able to communicate with the other member, such as through chat, blog, e-mail, SMS, video, or any other form of communication.

The social networking discovery may be performed without requiring a member to be in proximity to the event. For example, any time after one or more members of one or more groups of the event management application reserves access to an event, purchase a ticket to an event, or reserves access to an activity module 151 may be configured to match the attending members based on their individual member profiles. In advance of the event or activity or when the member attends the event or activity, discovery sub-module 151 may be configured to notify the member of one or more other members in a same or different group who have a similar interest or background. Sub-module 151 may be configured to detect that the member is attending the event or activity through location tracking module 170.

In some implementations, notification by the discovery sub-module 151 may be based on a privacy setting of one or more members. For example, based on a member's privacy setting, discovery sub-module 151 may exclude that member from being shown to other members of other groups, or may show the member to other members with a similar interest or background, but exclude the member's identification information, location information, or any other private information. In some implementations, discovery sub-module may show a member's location information, if allowed by the member's privacy setting, so that other members having a similar interest or background (e.g., college friends) can locate him or her at the event or activity.

Real time experience module 150 may include an event-based gaming module 152, which may facilitate gaming among attending members at an event or at an activity in proximity to the event, such as at a tailgating party by the event or at a happy hour close to the event. The gaming may be presented through the client application, or another application that may be downloaded from database server 200 or any other storage device on to client device 400 or any other client device. In some implementations, the application may be downloadable only after the member arrives at the event or at an activity or is otherwise in proximity to the event or activity, which may be detected through location tracking module 170. The gaming may include a contest participation, interactive competition, or any other form of gaming. A contest participation may include, for example, prompting a member to predict balls or strikes at a sports event, predict a winner of a mascot race at a sports event, vote on a concert performance, or any other form of participation. An interactive competition may include, for example, virtual sports games between competing members, hide and seek games among competing members, or any other form of interactive competition. In advance of the event or activity or when the member attends the event or activity, discovery sub-module 152 may be configured to notify the member of one or more other members in a same or different group who have a similar interest or background which could facilitate a potential matching for event-based gaming. Module 152 may be configured to host the gaming, or may be configured to provide to the client devices a third party host platform for the gaming. In some implementations, the gaming provided by sub-module 152 may remain available after the event or activity. A user may play one of the games or review his or her score after the event or activity.

Real time experience module 150 may include memory capture sub-module 155, which may facilitate capturing member experiences at the event or activity. Sub-module 155 may be configured to receive multimedia (e.g., photographs, videos), comments, chats, from one or more members during the event or activity, and may be configured to store such information on database server 200 or any other storage device. One or more members may be able to access the information after the event or activity. In some implementations, sub-module 155 may be configured to associate the information with a privacy or access setting. For example, a photograph with a high privacy setting may be accessible only by a member from whom the photograph was received, while a photograph with a low privacy setting may be accessible by any member. In some implementations, sub-module 155 may rely on executing social networking integration module 160, or more specifically posting and content module 163, which may be configured to allow content captured through or stored by the event management application to be uploaded to a third party social networking system, such as Facebook®, Twitter®, or Tumblr®.

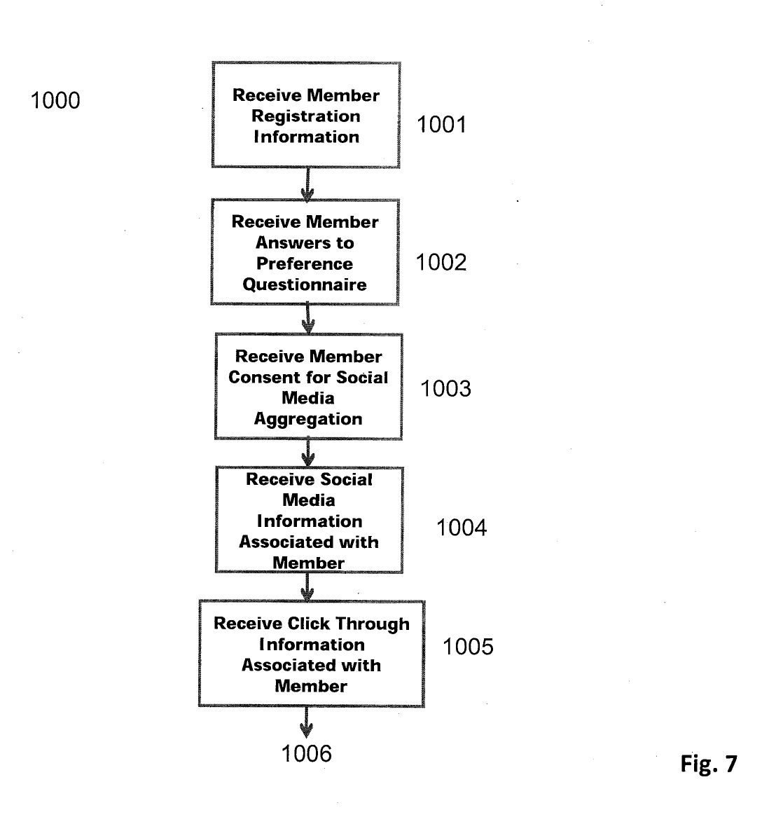

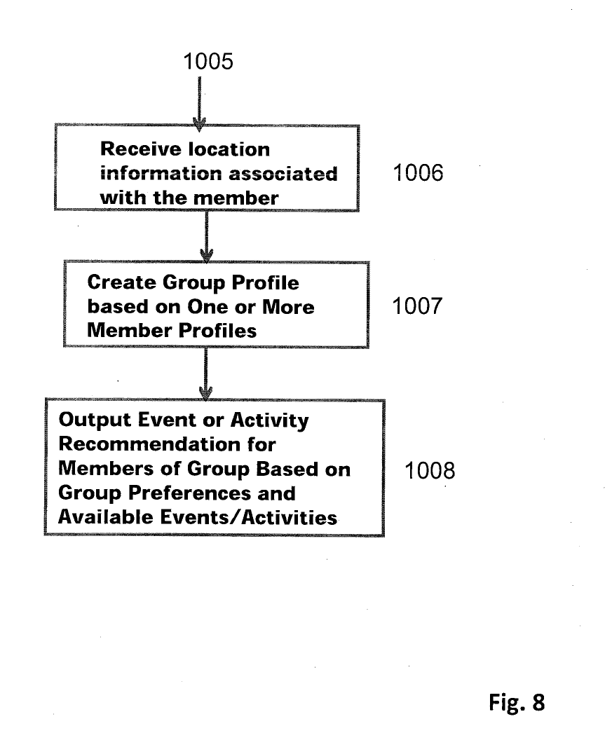

According to one aspect of the invention, FIGS. 7-8 illustrate an example process 1000 for recommending an event or activity based on a group preference. At an operation 1001, member registration information may be received. The registration information may be received by, for example, registration sub-module 111 or any other module. The user may provide registration for himself, or on behalf of another group member whom the user wants to attend an event with. The registration information may indicate the member's event or activity preferences, as discussed above. In one example, a preference questionnaire asking for a preferred event or activity type, venue, cost, or other preferences may be outputted to the member. At an operation 1002, answers to the questionnaire may be received. At an operation 1003, consent for social media aggregation may be received for the member. The consent may allow the member's social media accounts, such as Facebook®, Twitter®, Google+®, or any other account to be used to create or refine event preference information for the member, which may be received at operation 1004. At an operation 1005, information associated with the member's use of the event management application may be received. The information may be received at a variety of different times as the member browses through an interface presented by, for example, the event management application. Behavior indicated by use of the event management application (e.g., clickthrough behavior) may be used to create or refine event preference information for the member. In an operation 1006, location information associated with the member may be received. The information may indicate, for example, the member's proximity to one or more event or activity venues. An individual member profile may be created based on the received registration, social media, use of the event management application, and location information.

At an operation 1007, a group profile may be created based on one or more individual member profiles. The group may include one or more members for whom an event or activity will be recommended. In one example, the member from whom preference information at operations 1001-1006 was received may also identify who will be members of the group. The user may, for example, create a group at operation 1007 and indicate members of the group. The individual member profiles on which the group profile may be based may be preexisting individual member profiles created by their associated members, or may be newly created by the registering member, who may act as a proxy for the other members. At an operation 1008, an event or activity may be recommended to the group based on a group preference and available events and activities. The group preference may depend on who is in the group. For example, if a member indicates that he or she wants to attend an event with his or her children, an event such as Disney on Ice™ may be recommended if the event matches an interest of his or her children, even if it does not match an interest indicated from the member's own individual profile. The event or activity that is recommended may be based on a preference of one or more members of the group, on whether one member prefers to defer to another member of the group, on a relationship of the group members, or any combination thereof.

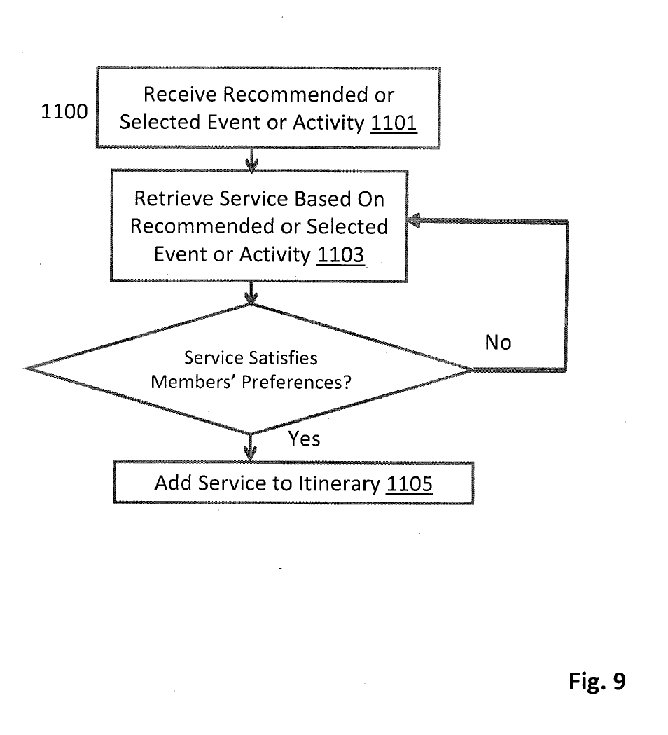

According to one aspect of the invention, FIG. 9 illustrates a process 1100 for generating an itinerary based on a recommended event or activity. At an operation 1101, the recommended event or activity may be received. For example, itinerary module 130 may receive the recommended event from event recommendation module 120. At an operation 1103, a service based on the recommended event may be retrieved. The service may be retrieved directly from a provider of the service, such as from a car rental company, a restaurant, or parking service, from an intermediary that compiles such services, or from a cached copy (e.g., cached copy on database server 200) of such information. The retrieved service may be filtered based on member preferences, such as cost, time, location, or any other preference information, which may be determined through member profiles. If the retrieved services do not satisfy one or more preferences of a member, an additional service may be retrieved. If the retrieved service does satisfy one or more preferences of the member, the service may be added to the itinerary at operation 1105. A member may be able to prioritize which preference (e.g., cost) is more important and needs to be satisfied, and which preference (e.g., proximity to event) is less important and may be only partially satisfied. Additional services may be retrieved and added to the itinerary if they satisfy one or more preferences of the member. The itinerary created at process 1100 may be created for a single member, or may be created for multiple members. Although the example above discusses retrieving and filtering services based on a recommended event or activity, services may also be retrieved or filtered based on an event manually selected by a user.

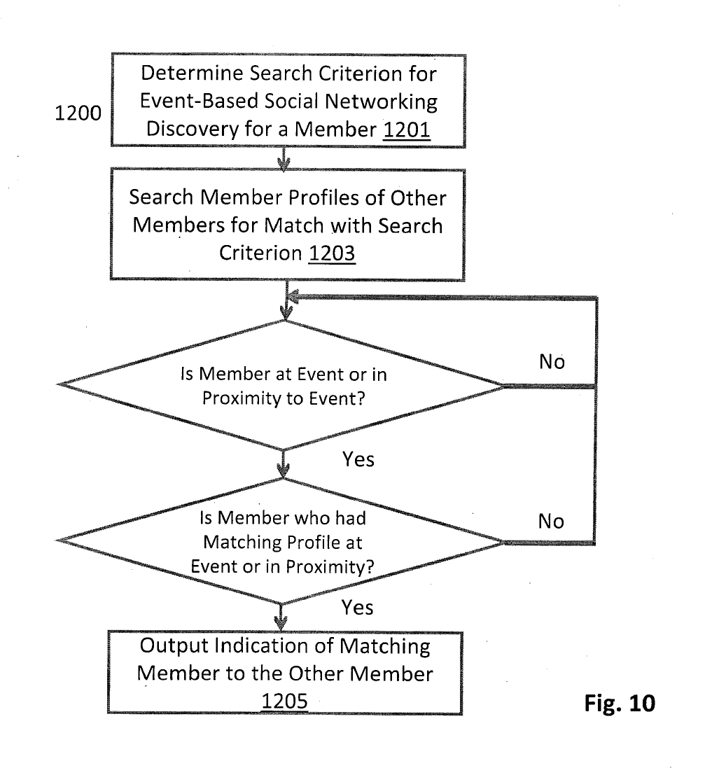

According to one aspect of the invention, FIG. 10 illustrates a process 1200 for facilitating social networking discovery at an event or activity. At an operation 1201, a search criterion for event-based social networking discovery for a member may be determined. For example, operation 1201 may determine a high school attended or a favorite musician as a criterion for matching the member with other attending members. Operation 1201 may be performed at the event or activity, at any time after the member has purchased a ticket or otherwise reserved access to the event or activity, or at any other time. At an operation 1203, one or more member profiles may searched to determine if the one or more profiles match the search criterion. The one or more member profiles that are searched may include all member profiles, or only profiles of those members who reserved access to the same event or activity. For example, the search may identify, from event attendance information stored on a database server, whether a member associated with a member profile will attend a recommended event or activity. If the member will attend the event or activity, his or her profile may be accessed to determine whether it matches the determined criterion. Operation 1203 may thus determine a plurality of attending members who, for example, have the same favorite musician or who went to the same high school or college. Operation 1203 may search based on one criterion or a plurality of search criteria. If a match is found amongst at least two members who will be attending the event or activity, an indication of the match may be outputted at an operation 1205 when both members have later arrived at the event or activity. In some implementations, the indication of the match may be outputted if only one of the members have arrived at the event or activity. In some implementations, the indication may output only the existence of a match without identifying who the matching members are. Permission from the matching members may be first obtained before their identities are revealed to the other members. In some implementations, the matching members may be able to contact each other through the event management application. For example, the event management application may relay a chat message from one client device to another or allow the members to make a phone call conferencing in each other, emailing each other, chatting with each other, blogging or text messaging each other through module 151 while preserving the privacy of their own individual phone numbers, email addresses, and other personal information.

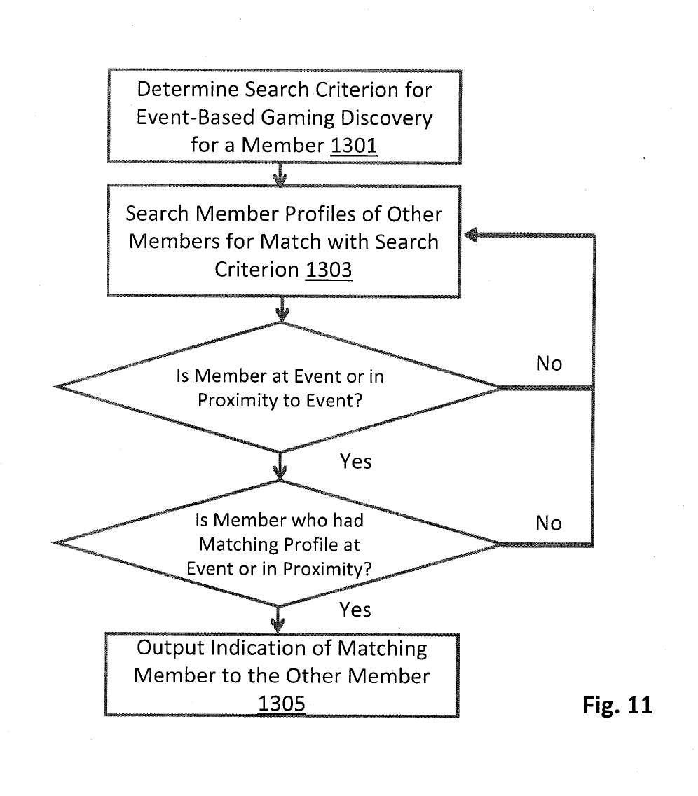

According to one aspect of the invention, FIG. 11 illustrates a process 1300 for facilitating social gaming at an event. The gaming may include, for example, contest participation or interactive competitions. In some implementations, an attending member may play with one or more other, randomly selected member. In some implementations, an attending member may play with another member having a similar interest or background. At an operation 1301, the search criterion may be determined. Operation 1301 may be performed at the event or activity, at any time after the member has purchased a ticket or otherwise reserved access to the event, or at any other time. At an operation 1303, one or more member profiles may be searched to determine if the one or more profiles match the search criterion. The one or more member profiles that are searched may include all member profiles, or only profiles of those members who reserved access to the same event or activity. Operation 1303 may thus determine a plurality of attending members who, for example, have similar gaming preferences. Operation 1303 may search based on one criterion or a plurality of search criteria. If a match is found among at least two members who will be attending, an indication of the match may be outputted at an operation 1305 when both members have later arrived at the event or activity. In some implementations, the indication of the match may be outputted if only one of the members have arrived at the event or activity. In some implementations, the indication may output only the existence of a match without identifying who the matching members are. Permission from the matching members may be first obtained before their identities are revealed to the other members. In some implementations, the matching members may be able to contact each other through the event management application. For example, the event management application may relay a chat message from one client device to another or allow the members to make a phone call conferencing in each other, emailing each other, chatting with each other, blogging or text messaging each other through module 152 while preserving the privacy of their own individual phone numbers, email addresses, and other personal information.

Implementations of the invention may be made in hardware, firmware, software, or any suitable combination thereof. The invention may also be implemented as instructions stored on a machine-readable medium that can be read and executed on one or more processing devices. For example, the machine-readable medium may include various mechanisms that can store and transmit information that can be read on the processing devices or other machines (e.g., read only memory, random access memory, magnetic disk storage media, optical storage media, flash memory devices, or any other storage or non-transitory media that can suitably store and transmit machine-readable information). Furthermore, although firmware, software, routines, or instructions may be described in the above disclosure with respect to certain exemplary aspects and implementations performing certain actions or operations, it will be apparent that such descriptions are merely for the sake of convenience and that such actions or operations in fact result from processing devices, computing devices, processors, controllers, or other hardware, executing the firmware, software, routines, or instructions. Moreover, to the extent that the above disclosure describes executing or performing certain operations or actions in a particular order or sequence, such descriptions are exemplary only and such operations or actions may be performed or executed in any suitable order or sequence.

Furthermore, aspects and implementations may be described in the above disclosure as including particular features, structures, or characteristics, but it will be apparent that every aspect or implementation may or may not necessarily include the particular features, structures, or characteristics. Further, where particular features, structures, or characteristics have been described in connection with a specific aspect or implementation, it will be understood that such features, structures, or characteristics may be included with other aspects or implementations, whether or not explicitly described. Thus, various changes and modifications may be made to the preceding disclosure without departing from the scope or spirit of the invention, and the specification and drawings should therefore be regarded as exemplary only, with the scope of the invention determined solely by the appended claims.

What we claim is:

1. A recommendation method, comprising:
accessing a group profile that includes preference information for each of a plurality of members, wherein the group profile is associated with a group having the plurality of members,
determining a group preference based on the group profile;
selecting, from among a plurality of events or activities, an event or activity for the plurality of members of the group to attend or do, the selecting based on the group preference; and
outputting the event or activity to one or more members of the group, wherein the group preference is based on a preference of at least one of the plurality of members.

2. The method of claim 1, wherein selecting the event or activity comprises selecting the event for the plurality of members of the group to attend.

3. The method of claim 2, wherein the plurality of events are live performance events.

4. The method of claim 2, wherein the group preference is further based on a relationship among the plurality of members.

5. The method of claim 4, wherein the preference information for one of the plurality of members indicates a preferred performer, preferred venue, preferred time, preferred travel distance, or preferred cost of the member.

6. The method of claim 5, wherein the preference information for the one of the plurality of members includes a member profile, and wherein the member profile is based on social media activity of the member, clickthrough information associated with the one member, or a location associated with the one member.

7. The method of claim 4, wherein the relationship is a family relationship, a marital relationship, a dating relationship, a friendship relationship, an acquaintance relationship, or a business relationship, the event selected for one of the relationships being different than the event selected for another one of the relationships.

8. The method of claim 2, wherein the group preference is based on a preference of more than one of the plurality of members, and wherein the preference of at least two of the more than one of the plurality of members are weighted differently.

9. The method of claim 1, further comprising outputting a service that is ancillary to the event or activity, the service including a transportation service, a parking service, a lodging service, or food or drink service.

10. The method of claim 9, wherein outputting the event or activity to the one or more users of the group comprises presenting the event or activity and the service in an itinerary.

11. The method of claim 1, further comprising transmitting a first set of payment information and a second set of payment information to obtain access to the event, activity, or service, wherein the first set of payment information is associated with a first member of the group and the second set of payment information is associated with a second member of the group.

12. A method for creating an itinerary, comprising:
accessing a profile that includes event preference information for a member of a group;
selecting, from among a plurality of events and activities, an event or activity for the member of the group to attend or do, wherein the selection is based on the profile; and
outputting an itinerary that includes the selected event or activity and includes an ancillary service.

13. The method of claim 12, wherein the ancillary service that is outputted is based on the profile.

14. The method of claim 12, further comprising outputting an itinerary management interface, the interface presenting a map that represents the event on the map and represents one or more activities or ancillary services on the map, wherein the activity or ancillary service that is outputted is based on user input that selects the ancillary event on the map from the one or more ancillary services.

15. The method of claim 12, wherein the group includes a plurality of members, wherein the selected event is for the plurality of members of the group to attend, and wherein outputting the itinerary comprises outputting at least one itinerary for the group.

16. The method of claim 15, wherein the outputting the itinerary comprises outputting at least one itinerary for each of the plurality of members of the group, wherein an itinerary for one of the plurality of members is different than an itinerary for another of the plurality of members.

17. The method of claim 15, wherein the outputting the itinerary comprises outputting a plurality of itineraries for at least one of the plurality of members of the group and outputting a difference between at least two of the plurality of itineraries.

18. The method of claim 15, further comprising:
outputting an itinerary management interface to each of the plurality of members, the interface presenting the at least one itinerary; and
receiving a user input related to the itinerary from at least two of the plurality of members.

19. The method of claim 18, wherein the user input comprises a text input, a poll response, payment information, or a command to modify the itinerary.

20. The method of claim 18, wherein the ancillary service includes a transportation service, a parking service, a lodging service, or a food or drink service.

21. A preference aggregation method comprising:
receiving a first set of member preference information associated with a first member;
associating the first set of member preference information with the first member in a group profile;
receiving a second set of member preference information associated with a second member;
associating the second set of member preference information with the second member in the group profile.

22. The preference aggregation method of claim 21, wherein the first set of member preference information is associated with a first member profile of the group profile, and wherein the second set of member preference information is associated with a second member profile of the group profile, and wherein receiving the first set or second set of member preference information comprises receiving member preference information from an electronic social networking system, receiving clickthrough information from a client device associated with the first member or second member, or receiving location information associated with the first member or the second member.

23. A method for providing content for an event, comprising:
receiving a request from a client device to access multimedia content associated with the event;
determining an identity of a member associated with the client device;
determining whether the member will be attending the event; and
outputting the requested multimedia content based at least on whether the member is determined to be attending the event.

24. The method of claim 23, wherein determining whether the member will be attending the event comprises determining whether the member has purchased access to the event.

25. The method of claim 23, further comprising determining whether the member is at the event or in proximity to the event, wherein the outputting the requested multimedia content is further based on whether the member is at the event or in proximity to the event.

26. The method of claim 23, wherein the multimedia content shows an interview, rehearsal, warm-up, or camera footage of the event.

27. A method for providing event-based social media, comprising:
accessing a plurality of member profiles;
determining, based on the plurality of member profiles, at least two members having a matching or substantially matching feature;
determining whether both of the at least two members will be attending the event, are at the event, or are in proximity of the event, wherein reserving access to an event includes purchasing a ticket to the event; and
outputting to one of the at least two members information indicative of the other of the at least two members if both of the at least two members have reserved access to the event, are at the event, or are in proximity of the event.

28. The method of claim 27, wherein determining whether both of the at least two members will be attending the event comprises determining whether both of the at least two members have purchased access to the event.

29. The method of claim 27, wherein each of the accessed member profiles is associated with a member for whom an event to attend has been recommended.

30. The method of claim 27, wherein the determining at least two members having a matching or substantially matching feature comprises determining at least two members having a matching or substantially matching interest or background.

31. The method of claim 27, further comprising transmitting gaming information related to a first game to a first member of the at least two members and to a second member of the at least two members.

32. The method of claim 31, further comprising:
receiving an input related to the first game from the first member;
determining a change to the first game based on the input;
outputting the change to the second member.

33. A system for providing a recommendation, comprising:
one or more processors configured to:
access a group profile that includes preference information for each of a plurality of members, wherein the group profile is associated with a group having the plurality of members,
determine a group preference based on the group profile;
select, from among a plurality of events or activities, an event or activity for the plurality of members of the group to attend or do, the selecting based on the group preference, and
output the event or activity to one or more members of the group, wherein the group preference is based on a preference of at least one of the plurality of members.

34. The system of claim 33, wherein the one or more processors are configured to determine the group preference based on a relationship among the plurality of members.

35. The system of claim 33, wherein the one or more processors are configured to determine the group preference based on a preference of more than one of the plurality of members, and wherein the preference of at least two of the more than one of the plurality of members are weighted differently.

36. The system of claim 33, wherein the one or more processors are configured to transmit a first set of payment information and a second set of payment information to obtain access to the event, to the activity, or to access a service that is ancillary to the event or activity, wherein the first set of payment information is associated with the first member of the group and the second set of payment information associated with a second member of the group.

37. A system for creating an itinerary, comprising:
one or more processors configured to:
access a profile that includes event preference information for a member of a group;
select, from among a plurality of events, an event for the member of the group to attend, wherein the one or more processors are configured to select the event based on the profile;
output an itinerary that includes the selected event and an ancillary service, wherein the ancillary service includes a transportation service, a parking service, a lodging service, or a food or drink service.

38. The system of claim 37, wherein the one or more processors are configured to output an itinerary management interface, the interface presenting a map that represents the event on the map and represents one or more ancillary services on the map, wherein the ancillary service that is outputted is based on user input that selects the ancillary event on the map from the one or more ancillary services.
